(19) United States
(12) Patent Application Publication
(10) Pub. No.: US 2021/0164630 A1
(43) Pub. Date: Jun. 3, 2021

(54) LIGHTING DEVICE

(71) Applicant: SHARP KABUSHIKI KAISHA, Sakai City, Osaka (JP)

(72) Inventors: KYOKO MATSUURA, Sakai City, Osaka (JP); SHUMPEI NISHINAKA, Sakai City, Osaka (JP); TSUYOSHI KAMADA, Sakai City, Osaka (JP); SHUN UEKI, Sakai City, Osaka (JP); TOSHIYUKI NOBUOKA, Sakai City, Osaka (JP)

(21) Appl. No.: 17/057,073

(22) PCT Filed: May 17, 2019
(86) PCT No.: PCT/JP2019/019672

§ 371 Date: Nov. 19, 2020

(30) Foreign Application Priority Data
May 24, 2018 (JP) 2018-099849
Sep. 6, 2018 (JP) 2018-167117

(51) Int. Cl. F21S 11/00

(52) U.S. Cl. CPC F21S 11/007

(57) ABSTRACT

The lighting device includes: a lighting film having a rectangular shape including a first surface and a second surface; and a support member configured to support the lighting film on at least two opposite sides of four sides of the lighting film so that a first surface and a second surface are positioned substantially parallel to a vertical direction, wherein the support member includes: a first support portion disposed opposite the first surface; a second support portion disposed opposite the second surface; an own weight support portion supporting an own weight of the lighting film; and a stretch allowance portion configured to allow elongation or shrinkage in a direction parallel to the first surface and the second surface of the lighting film due to a change in temperature.

### TECHNICAL FIELD

The present invention relates to a lighting device.

The present application claims priority to JP 2018-099849 A filed in Japan on May 24, 2018, and JP 2018-167117 A filed in Japan on Sep. 6, 2018, of which contents are incorporated herein by reference.

### BACKGROUND ART

Lighting devices for drawing sunlight into rooms through windows of buildings and the like are conventionally known. For example, PTL 1 described below proposes a lighting device including a lighting film in which a film base portion in which a plurality of fine structures are provided on one surface, a protective layer covering the plurality of fine structures, and a plate-like member provided on the other surface of the film base material are laminated via an adhesive layer. PTL 2 describes a hanging wall member containing a flexible sheet in an outer frame.

### CITATION LIST

### Patent Literature

PTL 1: JP 2013-156554 A

PTL 2: JP 2016-129582 A

### SUMMARY OF INVENTION

### Technical Problem

In the configuration described in PTL 1, since the coefficients of linear expansion of the members constituting the lighting film are different, in a case where members of different materials are bonded together, warping or deflection of the lighting film due to changes in the surrounding thermal environment occur due to differences in the respective ratios of expansion and contraction, and the appearance thereof is affected. PTL 2 proposes a configuration that prevents the occurrence of wrinkling of a flexible sheet by fitting the flexible sheet into an outer frame. However, because a portion of the flexible sheet is fixed to the outer frame, deflection of the flexible sheet is difficult to prevent, and overall deformation tends to occur. Therefore, this configuration cannot be applied to a lighting device.

One aspect of the present invention has been made in view of the problems of the known technology described above, and an object of the present invention is to provide a lighting device capable of preventing warping, deflection, and deformation of a lighting film due to changes in the surrounding thermal environment.

### Solution to Problem

A lighting device of one aspect of the present invention includes: a lighting film having a rectangular shape including a first surface and a second surface; and a support member configured to support the lighting film on at least two opposite sides of four sides of the lighting film so that the first surface and the second surface are positioned substantially parallel to a vertical direction, wherein the support member includes: a first support portion disposed opposite the first surface; a second support portion disposed opposite the second surface; an own weight support portion supporting an own weight of the lighting film; and a stretch allowance portion configured to allow elongation or shrinkage in a direction parallel to the first surface and the second surface of the lighting film due to a change in temperature.

A lighting device of one aspect of the present invention may have a configuration in which the support member includes an upper side member provided along an upper side of the lighting film and a lower side member provided along a lower side of the lighting film, the upper side member includes an upper groove into which an upper side of the lighting film is inserted, the lower side member includes a lower groove into which a lower side of the lighting film is inserted, the own weight support portion is constituted by a bottom portion of the lower groove or a bottom portion of the upper groove, and the stretch allowance portion is constituted by a gap between the upper side of the lighting film and the bottom portion of the upper groove or a gap between the lower side of the lighting film and the bottom portion of the lower groove.

A lighting device of one aspect of the present invention may have a configuration in which the lighting device satisfies Relationship (1) below in a case where a thickness of the lighting film is denoted by W1, a width of the upper groove or the lower groove is denoted by W2, and a depth of the upper groove or the lower groove is denoted by Lb.

Lb*tan 5°+W1*cos 5°≥W2>W1 (1)

A lighting device of one aspect of the present invention may have a configuration in which the support member includes an upper side member provided along an upper side of the lighting film and a lower side member provided along a lower side of the lighting film, a hole is provided in a region on a side of the upper side of the lighting film, the upper side member includes an upper side member main body and an insertion member inserted through the hole of the lighting film, and the own weight support portion is constituted by the insertion member.

A lighting device of one aspect of the present invention may have a configuration in which the lower side member includes a lower groove into which the lower side of the lighting film is inserted, and the stretch allowance portion is constituted by a gap between the lower side of the lighting film and a bottom portion of the lower groove.

A lighting device of one aspect of the present invention may have a configuration in which the lower side member includes a lower side opening portion penetrating up and down and into which the lower side of the lighting film is inserted, and the stretch allowance portion is constituted by the lower side opening portion.

A lighting device of one aspect of the present invention may have a configuration in which a screw hole penetrating in a horizontal direction is provided in the upper side member main body, and the insertion member is constituted by the screw hole of the upper side member main body and a screw inserted through the hole of the lighting film.

A lighting device of one aspect of the present invention may have a configuration in which, in the lighting film, a longitudinal dimension of an exposed portion exposed from the upper side member and the lower side member is greater than a total of a longitudinal dimension of an unexposed portion covered by the upper side member and the lower side member.

A lighting device of one aspect of the present invention may be configured further including: a suppressing member disposed opposite the first surface and the second surface in an exposed portion of the lighting film exposed from the support member, and the suppressing member suppressing deflection of the lighting film.

A lighting device of one aspect of the present invention may have a configuration in which the first support portion includes a first surface disposed opposite a window surface, the second support portion includes a second surface disposed toward an indoor side, and a distance from the first surface of the first support portion to the first surface of the lighting film is less than a distance from the second surface of the second support portion to the second surface of the lighting film.

A lighting device of one aspect of the present invention may be configured further including: at least one or more protective sheets supported by the support member and covering at least a portion of the first surface or at least a portion of the second surface of the lighting film.

A lighting device of one aspect of the present invention may be configured including: a lighting film including a first surface for light to enter and a second surface that is opposed to the first surface and that emits the light of entry, the lighting film emitting the light of entry in a predetermined direction; and a support member including a first support portion disposed opposite the first surface, a second support portion disposed opposite the second surface, and a stretch allowance portion configured to allow elongation or shrinkage of the lighting film due to a change in temperature.

A lighting device of one aspect of the present invention may have a configuration in which the stretch allowance portion is a gap portion between the support member and the lighting film.

A lighting device of one aspect of the present invention may have a configuration in which the support member supports the lighting film on at least two opposite sides of four sides of the lighting film on a rectangle so that the first surface and the second surface are arranged in a vertical direction.

A lighting device of one aspect of the present invention may have a configuration in which the support member includes a groove configured to house an end portion of the lighting film.

A lighting device of one aspect of the present invention may have a configuration in which a movement suppressing portion configured to suppress movement of the lighting film is provided between the support member and the lighting film.

A lighting device of one aspect of the present invention may have a configuration in which the movement suppressing portion is a protrusion portion in contact with the lighting film provided on the support member.

A lighting device of one aspect of the present invention may have a configuration in which the movement suppressing portion is constituted by a material having a Young's modulus lower than that of the support member.

A lighting device of one aspect of the present invention may have a configuration in which the movement suppressing portion is constituted by a same material as the support member.

A lighting device of one aspect of the present invention may have a configuration in which the movement suppressing portion is a bent portion provided in the lighting film by bending a portion of an end portion of the lighting film.

A lighting device of one aspect of the present invention may have a configuration in which a ridge portion formed linearly along an end portion of the lighting film is provided on the protrusion portion.

A lighting device of one aspect of the present invention may have a configuration in which one or more protruding portions are provided on the protrusion portion.

A lighting device of one aspect of the present invention may have a configuration in which the movement suppressing portion has a concave-convex shape formed on a surface.

### Advantage Effects of Invention

According to the present invention, a lighting device capable of preventing warping, deflection, and deformation of a lighting film due to changes in the surrounding thermal environment can be provided.

### BRIEF DESCRIPTION OF DRAWINGS

FIG. 1 is a front view illustrating the appearance of a lighting device 1 installed in a window, viewed from the indoor side (arrow A side illustrated in FIG. 2).

FIG. 2 is a cross-sectional view taken along line A-A′ of FIG. 1.

FIG. 3 is a perspective view illustrating a configuration of a lighting film 12.

FIG. 4 is a cross-sectional view illustrating a shape of a lighting portion 3.

FIG. 5 is a cross-sectional view illustrating a configuration of a lighting unit 10.

FIG. 6 is a diagram for explaining the positional relationship between a support member 13 and the lighting film 12.

FIG. 7 is a diagram for explaining a width dimension of a groove.

FIG. 8 is a diagram for explaining a shape of the support member 13.

FIG. 9A is a perspective view illustrating a configuration of a support member having three-sided support.

FIG. 9B is a perspective view illustrating a configuration of a support member having four-sided support.

FIG. 10 is a perspective view of a lighting unit 20 according to a second embodiment.

FIG. 11 is a cross-sectional view taken along line B-B′ of FIG. 10.

FIG. 12 is a perspective view of a lighting film 24.

FIG. 13 is a perspective view of a lighting unit 30 according to a third embodiment.

FIG. 14 is a cross-sectional view taken along line C-C′ of FIG. 13.

FIG. 15 is a perspective view of a lighting unit 40 according to a fourth embodiment.

FIG. 16 is a cross-sectional view taken along line D-D′ of FIG. 15.

FIG. 17 is a perspective view of a lighting unit 50 according to a fifth embodiment.

FIG. 18 is a cross-sectional view taken along line E-E′ of FIG. 17.

FIG. 19 is a perspective view of a lighting unit 60 according to a sixth embodiment.

FIG. 20 is a cross-sectional view taken along line F-F′ of FIG. 19.

FIG. 21 is a perspective view of a lighting unit 70 according to a seventh embodiment.

FIG. 22 is a cross-sectional view taken along line G-G′ of FIG. 21.

FIG. 23A is a perspective view illustrating a configuration in which pressing members are provided so as to extend in a horizontal direction.

FIG. 23B is a perspective view illustrating a configuration in which pressing members are provided so as to intersect in the horizontal direction and the vertical direction.

FIG. 24 is a cross-sectional view of a lighting unit 80 according to an eighth embodiment.

FIG. 25 is a cross-sectional view illustrating a modified example of a support axis structure.

FIG. 26 is a schematic view illustrating a configuration of a lighting device 200 installed in a window.

FIG. 27 is a schematic view illustrating a configuration of a lighting unit 210.

FIG. 28 is a schematic view illustrating a configuration of the lighting unit 210.

FIG. 29 is a schematic view illustrating a main portion of the lighting unit 210 according to a ninth embodiment.

FIG. 30 is a cross-sectional view taken along line XXX-XXX of FIG. 29.

FIG. 31 is a cross-sectional view of a lighting unit 215 of a tenth embodiment.

FIG. 32 is an enlarged view of a protrusion portion 216.

FIG. 33 is a cross-sectional view of a lighting unit 220 of an eleventh embodiment.

FIG. 34 is a schematic view illustrating a main portion of a lighting unit 225 of a twelfth embodiment.

FIG. 35 is a cross-sectional view of a lighting unit 230 according to another embodiment.

FIG. 36 is a cross-sectional view of a lighting unit 235 according to another embodiment.

### DESCRIPTION OF EMBODIMENTS

### First Embodiment

Hereinafter, a lighting device 1 according to a first embodiment of the present invention will be described.

Note that, in each of the drawings below, the scale of the dimensions may be illustrated differently depending on the constituent elements in order to facilitate viewing of the components.

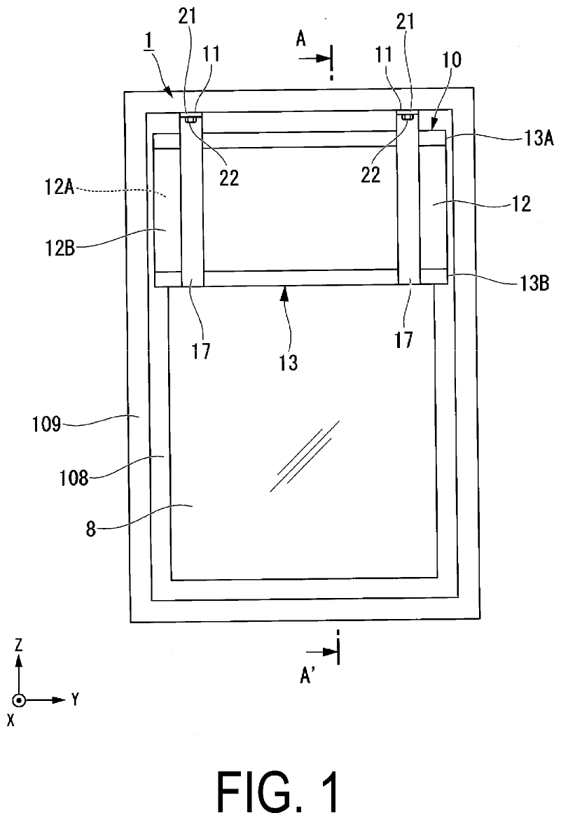

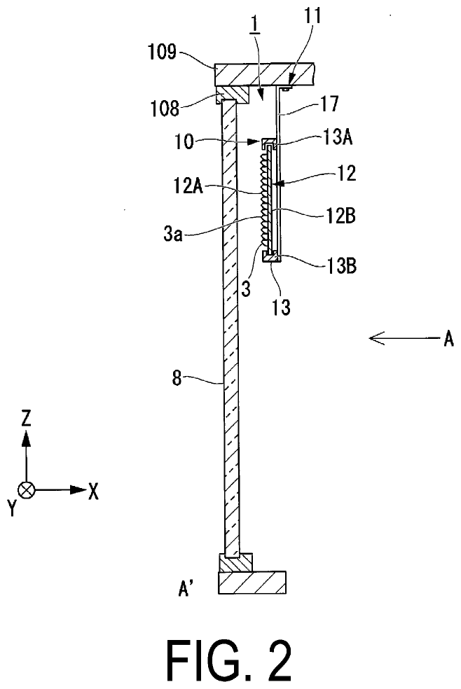

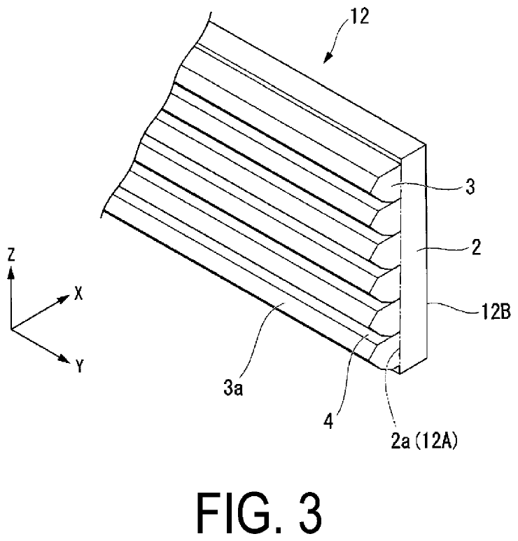

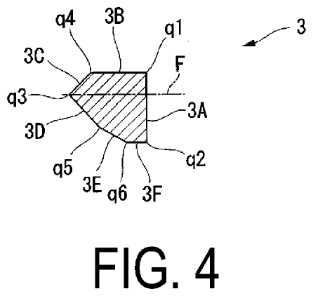

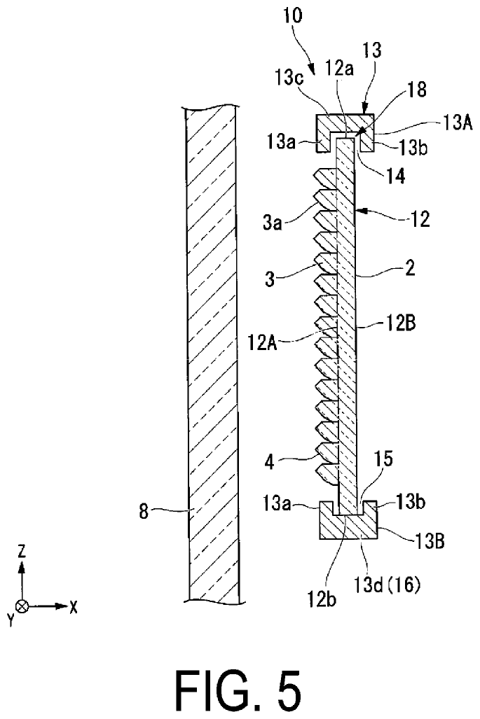

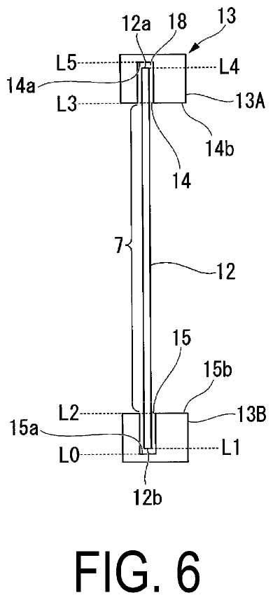

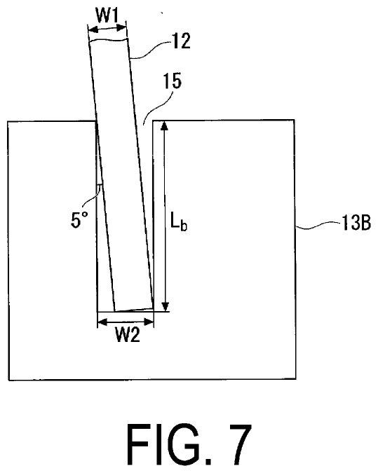

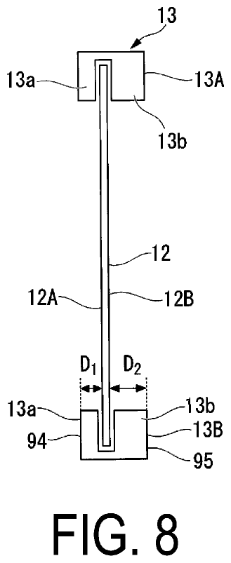

FIG. 1 is a front view illustrating the appearance of a lighting device 1 installed in a window, viewed from the indoor side (arrow R side illustrated in FIG. 2). FIG. 2 is a cross-sectional view taken along line A-A′ of FIG. 1. FIG. 3 is a perspective view illustrating a configuration of a lighting film 12. FIG. 4 is a cross-sectional view illustrating a shape of a lighting portion 3. FIG. 5 is a cross-sectional view illustrating a configuration of a lighting unit 10. FIG. 6 is a diagram for explaining the positional relationship between a support member 13 and the lighting film 12. FIG. 7 is a diagram for explaining a width dimension of a groove. FIG. 8 is a diagram for explaining a shape of the support member 13.

As illustrated in FIGS. 1 and 2, the lighting device 1 includes a lighting unit 10 including a lighting film 12 and a support member 13, and a pair of mounting portions 11. The reference sign 8 illustrated in FIG. 1 denotes a window glass, the reference sign 108 denotes a window sash, and the reference sign 109 denotes a window frame.

### Lighting Film

As illustrated in FIGS. 3 and 5, the lighting film 12 is a rectangular film having a light incident surface (first surface) 12A and a light emission surface (second surface) 12B. The lighting film 12 includes a base portion 2 having light transmittance, a plurality of lighting portions 3 provided on a first surface 2a of the base portion 2, and gap portions 4 provided between the plurality of lighting portions 3. The plurality of lighting portions 3 reflect and refract incident external light and direct the light into the room. Note that the light incident surface 12A of the lighting film 12 is different from the light incident surface of each of the lighting portions 3, and as illustrated in FIG. 5, the light incident surface 12A is defined as the same virtual plane as the first surface 2a of the base portion 2, which will be described later.

Note that in the present embodiment, the plurality of lighting portions 3 are formed integrally with the base portion 2 with the same material as the base portion 2. Therefore, the interface between the plurality of lighting portions 3 and the base portion 2 is not actually present, but for convenience of explanation, in the drawing of FIG. 3, the first surface 2a of the base portion 2 is illustrated as a virtual plane (dot-dash line) that forms the same plane as the first surface 3A (FIG. 4) of the lighting portion 3 described below.

The base portion 2 and the lighting portions 3 are formed from an ultraviolet (UV) curing resin or a thermosetting resin. Specific examples of the UV curing resin include urethane acrylate, acrylic resin acrylate, epoxy acrylate, and the like. Examples of the thermosetting resin include amino resins, urea resins, polyurethanes, epoxy resins, unsaturated polyester resins, and the like.

A resin material obtained by mixing a polymerization initiator, a coupling agent, a monomer, an organic solvent, or the like can be used as the resin material described above. Furthermore, the polymerization initiator may include various additives such as stabilizers, inhibitors, plasticizers, optical brighteners, release agents, chain transfer agents, other photopolymerizable monomers.

As illustrated in FIG. 3, each of the plurality of lighting portions 3 extends in the longitudinal direction of the base portion 2, and is disposed side by side in the lateral direction of the base portion 2. As illustrated in FIG. 4, the lighting portion 3 is constituted in a prism structure having a polygonal cross-sectional shape perpendicular to the longitudinal direction. The lighting portion 3 has six top portions q1 to q6 in a cross-sectional shape perpendicular to the longitudinal direction, for example, and is a hexagonal shape with an internal angle of each of the top portions q1 to q6 being less than 180°. Of the surfaces 3A to 3F of the lighting portion 3, the fourth surface 3D, the fifth surface 3E, and the sixth surface 3F located below the virtual plane F perpendicular to the first surface 3A that passes through the top portion q3 function as reflection surfaces that reflect light incident from the second surface 3B or the third surface 3C.

Air is present in the gap portions 4 (space) between adjacent lighting portions 3. Therefore, the interface between the lighting portion 3 and the gap portion 4 is the interface between the resin and the air. The gap portions 4 may be filled with other low refractive index materials. However, the difference in refractive index at the interface between the interior and the exterior of the lighting portion 3 is maximum in a case where air is present than a case where any low refractive index material is present in the exterior.

### Support Member

As illustrated in FIGS. 1 and 5, the support member 13 supports the lighting film 12 in at least two opposing sides (in the present embodiment, the upper side 12a and the lower side 12b, see FIG. 5) among four sides of the lighting film 12, so that the light incident surface 12A and the light emission surface 12B are positioned substantially parallel with the vertical direction. As illustrated in FIG. 5, the support member 13 includes at least an upper side member 13A provided along the upper side 12a of the lighting film 12 and a lower side member 13B provided along the lower side 12b of the lighting film 12. The upper side member 13A and the lower side member 13B have the same configuration as each other, for example, made of aluminum, but different configurations may be used.

The upper side member 13A has an upper groove 14 into which an upper side 12a of the lighting film 12 is inserted. The upper groove 14 is formed by a first support portion 13a disposed opposite the light incident surface 12A of the lighting film 12, a second support portion 13b disposed opposite the light emission surface 12B, and an upper side connecting portion 13c that connects the first support portion 13a and the second support portion 13b in the upper side member 13A.

The lower side member 13B has a lower groove 15 into which the lower side 12b of the lighting film 12 is inserted. The lower groove 15 is formed by a first support portion 13a, a second support portion 13b, and a lower side connecting portion 13d that connects the first support portion 13a and the second support portion 13b in the lower side member 13B. The lower side connecting portion 13d of the lower side member 13B is the bottom portion of the lower groove 15, and functions as an own weight support portion 16 that supports the own weight of the lighting film 12 inserted into the lower groove 15.

As illustrated in FIG. 1, the support member 13 further includes a pair of coupling members 17 and 17 that connect the upper side member 13A and the lower side member 13B. The pair of coupling members 17 and 17 are members that fix the upper side member 13A and the lower side member 13B to keep in a parallel state with each other along the upper side 12a (FIG. 5) and the lower side 12b (FIG. 5) of the lighting film 12, and extend perpendicular to the upper side member 13A and the lower side member 13B. One of the coupling members 17 connects one end sides of the upper side member 13A and the lower side member 13B, and the other coupling member 17 connects the other end sides of the upper side member 13A and the lower side member 13B.

In the present embodiment, as illustrated in FIG. 5, the upper side member 13A and the lower side member 13B are connected at a slightly larger interval than the vertical dimension of the lighting film 12. The coupling members 17 and 17 are desirably provided at a position that does not interfere with the lighting function of the lighting film 12, and the size, shape, and the like are not limited to those illustrated.

As illustrated in FIG. 5, the lighting film 12 inserted into the upper groove 14 and the lower groove 15 of the support member 13 is stored in a flat state and held vertically. The lighting film 12 housed in the support member 13 has the lower side 12b projecting against the lower side connecting portion 13d of the lower groove 15, and its own weight is supported by the own weight support portion 16, which is the bottom portion of the lower groove 15.

On the other hand, as described above, the upper side member 13A and the lower side member 13B have an interval with a space that is more leeway than in the vertical dimension of the lighting film 12, so the upper side 12a side of the lighting film 12 does not project against the bottom portion of the upper groove 14. The gap formed between the bottom portion of the upper groove 14, that is, the upper side connecting portion 13c of the upper side member 13A, and the upper side 12a of the lighting film 12 functions as a stretch allowance portion 18 according to an aspect of the present invention. The stretch allowance portion 18 is a portion that allows elongation or shrinkage in a direction parallel to the light incident surface 12A and the light emission surface 12B, along with a change in the temperature of the lighting film 12 housed within the support member 13.

Next, the dimensions and positional relationships of the members will be described in detail with reference to FIG. 6.

In FIG. 6, with the bottom surface 15a of the lower groove 15 in the lower side member 13B as the reference position L0, from the reference position L0, the distance to the lower side 12b of the lighting film 12 is L1, the distance to the opening side surface 15b of the lower groove 15 in the lower side member 13B is L2, the distance to the opening side surface 14b of the upper groove 14 in the upper side member 13A is L3, the distance to the upper side 12a of the lighting film 12 is L4, and the distance to the bottom surface 14a of the upper groove 14 in the upper side member 13A is L5.

In the present embodiment, as illustrated in FIG. 5, the lower side 12b of the lighting film 12 projects against the bottom portion of the lower groove 15 (L0=L1). In the upper groove 14, there is a gap referred to as the stretch allowance portion 18 between the upper side 12a of the lighting film 12 and the bottom portion of the upper groove 14, so the lighting film 12 does not contact the bottom portion of the upper groove 14 (L4<L5). Thus, the positional relationship of each member can be represented by L0=L1<L2<L3<L4<L5.

For the arrangement interval between the lower side member 13B and the upper side member 13A, the length from the bottom portion of the lower groove 15 to the bottom portion of the upper groove 14 is longer than the height dimension in the vertical direction of the lighting film 12, for example, by about 4 mm, so as to have a degree of freedom in the vertical direction of the lighting film 12.

Considering the dimensions of the stretch allowance portion 18 described above, the arrangement interval (L2-L3 distance) between the upper side member 13A and the lower side member 13B is smaller than the height dimension (L4-L1) in the vertical direction of the lighting film 12, so the structure is configured to support the lighting film 12 with the support member 13.

In the lighting film 12 housed in the support member 13, it is desirable that a dimension (L3-L2) in the vertical direction of the exposed portion 7 exposed from the upper side member 13A and the lower side member 13B of the support member 13 be greater than half of the vertical dimension (L4-L1) of the lighting film 12. It is desirable to fill L3-L2>(L4-L1)/2 in a case of expressing with the reference sings in FIG. 6.

The portion of the lighting film 12 inserted into the upper groove 14 and the lower groove 15 of the support member 13 is covered by the upper side member 13A and the lower side member 13B, so a lighting effect cannot be obtained. Therefore, it is desirable to configure the vertical dimension of the exposed portion 7 of the lighting film 12 larger than the total depth of the upper groove 14 and the lower groove 15, and to ensure a broad lighting region as much as possible.

Specifically, in a case where the dimension (L4-L1) of the lighting film 12 in the vertical direction is 330 mm, for example, the dimension (L3-L2) in the vertical direction of the exposed portion 7 of the lighting film 12 is preferably approximately 300 mm.

The depth (L5-L3) of the upper groove 14 and the depth (L2) of the lower groove 15 are each preferably from approximately 15 mm to 30 mm.

The width of the upper groove 14 and the lower groove 15 in the thickness direction of the lighting film 12 is slightly wider than the thickness of the lighting film 12 and is preferably from approximately 0.5 mm to approximately 3 mm with respect to the thickness of the lighting film 12.

Specifically, as illustrated in FIG. 7, the lighting film 12 is supported in a state of being inclined with respect to the lower groove 15 in contact with the inner wall surface or corner portion of the lower groove 15 of the lower side member 13B. Therefore, in a case where the thickness of the lighting film 12 is W1, the width of the lower groove 15 is W2, the depth of the upper groove or lower groove 15 is Lb, and the inclination angle of the lighting film 12 is 5°, it is desirable to satisfy Relationship (1) below.

Lb*tan 5°+W1*cos 5°≥W2>W1 (1)

Note that in a case where the lighting film 12 is in contact with the upper groove 14, the same as described above may be considered, and W2 of Relationship (1) may be set to the width of the upper groove 14.

The upper side member 13A and the lower side member 13B may each have an asymmetrical shape in the thickness direction. For example, as illustrated in FIG. 8, the thicknesses of the first support portion 13a and the second support portion 13b of the upper side member 13A and the lower side member 13B of the support member 13 may be different from each other.

As illustrated in FIG. 8, the first support portion 13a of each of the upper side member 13A and the lower side member 13B has a first surface 94 disposed opposite the window surface, and the second support portion 13b has a second surface 95 disposed toward the indoor side. In a case where the distance from the first surface 94 of the first support portion 13a to the light incident surface 12A of the lighting film 12 is D1, and the distance from the second surface 95 of the second support portion 13b to the light emission surface 12B of the lighting film 12 is D2, the first support portion 13a may have a thickness that is less than the thickness of the second support portion 13b such that the distance D1 from the first surface 94 of the first support portion 13a to the light incident surface 12A of the lighting film 12 is shorter than the distance D2 from the first surface 94 of the first support portion 13a to the light incident surface 12A of the lighting film 12 (D1<D2).

As illustrated in FIG. 1, the lighting unit 10 of the present embodiment is mounted in the room in a state of being suspended from the upper portion of the window frame 109 by a pair of mounting portions 11. Each of the mounting portions 11 includes an attachment member 21 for attaching the lighting unit 10 to the window frame 109, and a plurality of attachment screws 22. As illustrated, the attachment member 21 may be integrally formed with the coupling member 17 of the support member 13 described above, or may be a separate member from the coupling member 17.

In this way, the lighting unit 10 is installed in the window frame 109 via the mounting portions 11. As illustrated in FIG. 2, the lighting unit 10 is in a position in which the fine structural surface 3a of the lighting film 12 faces the window glass 8 and is parallel to the window glass 8.

In the present embodiment, the configuration is to accommodate only by inserting the lighting film 12 into the upper and lower grooves 14 and 15 of the support member 13, so it is not necessary to secure the upper side 12a and the lower side 12b of the lighting film 12 to the upper side member 13A and the lower side member 13B of the support member 13, with an adhesive, adhesive tape, and the like. Therefore, in a case where thermal expansion or thermal contraction occurs in the lighting film 12 due to the thermal environment inside the room in which the lighting device 1 is installed, wrinkles or warping originating from the adhering portion with respect to the support member 13 do not occur.

Furthermore, in the present embodiment, the distance between the bottom portions of the upper and lower grooves 14 and 15 in the support member 13 is configured to be longer than the height dimension of the lighting film 12. As a result, with the lighting film 12 housed in the upper and lower grooves 14 and 15 of the support member 13, a gap is created between the upper side 12a of the lighting film 12 and the bottom portion (upper side connecting portion 13c) of the upper groove 14, and this gap functions as a stretch allowance portion 18 that allows the lighting film 12 to expand and contract. As a result, the degree of freedom of stretching of the lighting film 12 within the support member 13 is ensured, and in a case where the lighting film 12 thermally expands or contracts, no external force is applied to the lighting film 12 from the support member 13, so the flatness of the lighting film 12 can be maintained. In this way, appearance changes due to warping, deflection, deformation, or the like of the lighting film 12 due to changes in the surrounding thermal environment can be prevented.

Furthermore, in the present embodiment, the width dimensions of the upper groove 14 and the lower groove 15 of the support member 13 are sized to satisfy Relationship (1) described above, so the inclination angle of the lighting film 12 in the thickness direction can be set to within 5° in a case where the lighting film 12 is inserted into the support member 13. In a case where the inclination angle in front and behind of the lighting film 12 is 5° or greater, the appearance of the lighting film 12 is affected, such as color cracking or glare, but by suppressing the inclination angle to within 5°, it is possible to suppress the effects on the appearance as described above.

As illustrated in FIG. 8, in a case where the thickness of the window side of the support member 13 is thinner than that of the indoor side, the lighting film 12 can be brought closer to the window, so the lighting effect can be increased.

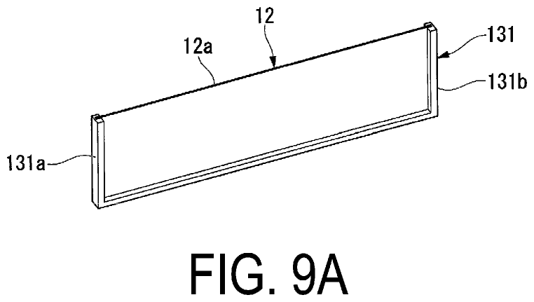

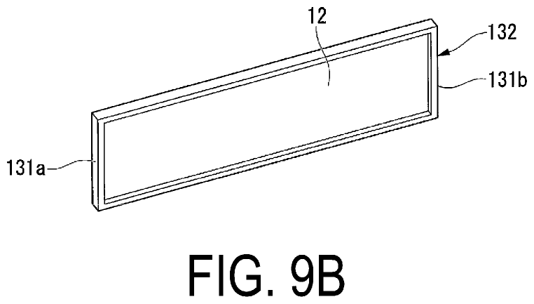

Note that in the present embodiment, two upper and lower sides of the lighting film 12 are supported by the support member 13, but no such limitation is intended. It is sufficient that at least two sides of the four sides of the lighting film 12 are supported by the support member 13, and for example, the configurations illustrated in FIGS. 9A and 9B may be used.

FIG. 9A illustrates a configuration in which three other sides other than the upper side 12a of the lighting film 12 are supported, and FIG. 9B illustrates a configuration in which all four sides of the lighting film 12 are supported. The support member 131 illustrated in FIG. 9A and the support member 132 illustrated in FIG. 9B each include a left side member 131a provided along the left side of the lighting film 12, and a right side member 131b provided along the right side of the lighting film 12, which are at least two sides facing each other.

Grooves (not illustrated) capable of inserting the left and right sides of the lighting film 12 are formed in the left side member 131a and the right side member 131b. Here, the distance between the bottom portions of the left and right grooves is set to be longer than the lateral width of the lighting film 12. As a result, it is possible to ensure the degree of freedom of stretching of the lighting film 12 in the left and right direction, and it is possible to prevent external forces from the support member 13 from being applied to the lighting film 12 in a case where the lighting film 12 expands or contracts.

### Second Embodiment

Next, a configuration of a second embodiment of a lighting unit 20 will be described.

The basic configuration of the lighting unit 20 described below is substantially the same as that of the first embodiment described above, but the configuration of the support member differs from that of the first embodiment.

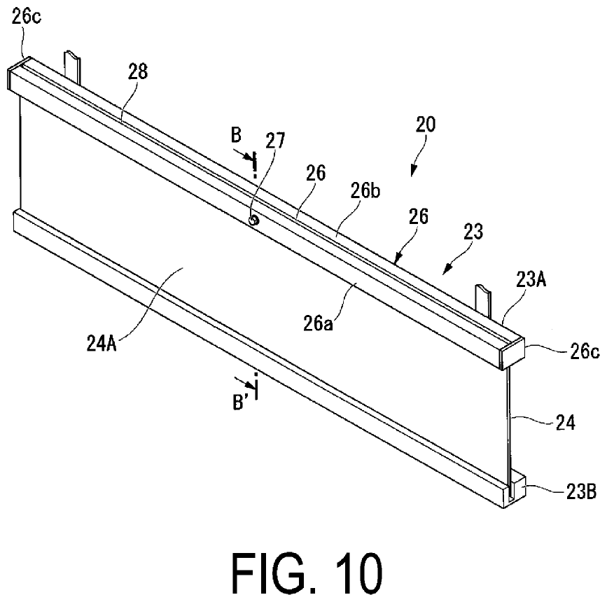

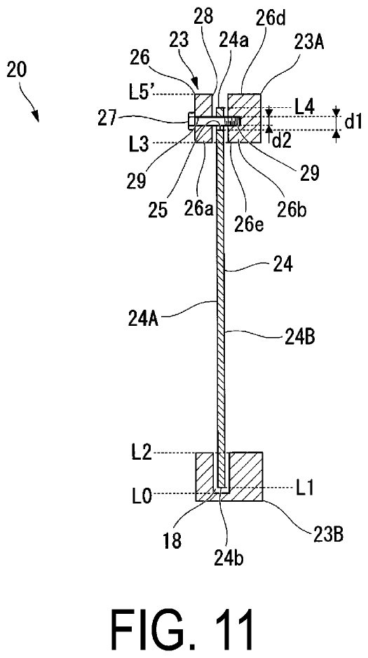

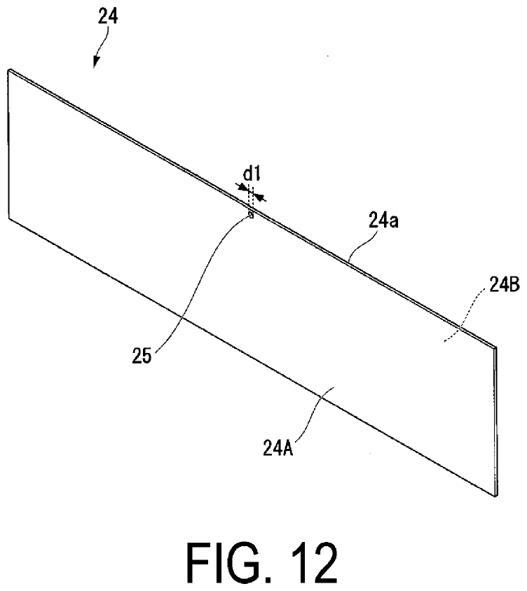

FIG. 10 is a perspective view of the lighting unit 20 according to the second embodiment. FIG. 11 is a cross-sectional view taken along line B-B′ of FIG. 10. FIG. 12 is a perspective view of a lighting film 24.

As illustrated in FIG. 10, the lighting unit 20 of the present embodiment includes a support member 23 having at least an upper side member 23A provided along an upper side 24a of the lighting film 24 and a lower side member 23B provided along the lower side 12b of the lighting film 24. As illustrated in FIG. 12, a hole 25 penetrating through the thickness direction is formed in a region on the upper side 24a side of the lighting film 24 substantially in the center in the length direction.

As illustrated in FIG. 11, the upper side member 23A includes an upper side member main body 26 and an insertion member 27. The upper side member main body 26 includes a first support portion 26a disposed opposite the light incident surface 24A of the lighting film 24, a second support portion 26b disposed opposite the light emission surface 24B, and a pair of coupling members 26c and 26c that couple both end sides of the first support portion 26a and the second support portion 26b. The upper side member main body 26 has an upper side opening portion 28 that penetrates up and down. The upper side 24a of the lighting film 24 is inserted into the upper side opening portion 28. A screw hole 29 penetrating in the horizontal direction is provided in the first support portion 26a and the second support portion 26b of the upper side member main body 26.

The insertion member 27 is made of a screw and is inserted through the screw hole 29 of the first support portion 26aand the second support portion 26b in the upper side member main body 26, and is inserted through the hole 25 of the lighting film 24. The lighting film 24 is provided on the upper side member main body 26 via the insertion member 27 and is suspended from the insertion member 27. In other words, the own weight support portion of the present embodiment is constituted by the insertion member 27. The diameter d1 of the hole 25 of the lighting film 24 is preferably larger than the axial diameter d2 of the insertion member 27 (d1>d2). Note that an insertion pin may be used as the insertion member 27.

The lower side member 23B has a configuration similar to that of the first embodiment and includes a lower groove 15. A lower side 24b of the lighting film 24 is inserted into the lower groove 15.

In FIG. 11, in a case where the distance from the reference position L0 of the lower side member 23B to the lower surface 26e of the upper side member main body 26 is L3, the distance from the reference position L0 to the upper surface 26d is L5′, and L1, L2, and L4 are similar to FIG. 6, by setting the positional relationship of each member to be L0<L1<L2<L3<L4<L5′, the lower side 24b of the lighting film 24 can be floating from the bottom portion of the lower groove 15 without hitting the bottom portion of the lower groove 15. The gap between the lower side 24b of the lighting film 24 and the bottom portion of the lower groove 15 functions as a stretch allowance portion 18 that allows thermal expansion and thermal contraction of the lighting film 24.

As described above, in the present embodiment, the lighting film 24 is suspended in the support member 23 by the insertion member 27, and the lower side 24b is held floating from the bottom portion of the lower groove 15. For this reason, thermal expansion or thermal contraction of the lighting film 24 is allowed by the stretch allowance portion 18 formed between the lower side 24b and the bottom portion of the lower groove 15. As a result, as in the previous embodiment, the external force from the support member 23 is not applied in a case where thermal expansion or thermal contraction of the lighting film 24 occurs, so the flatness of the lighting film 24 can be maintained, and changes in the appearance due to deflection, deformation, and the like of the lighting film 24 can be prevented.

The diameter d1 of the hole 25 of the lighting film 24 is formed larger than the axial diameter d2 of the insertion member 27 (d1>d2), and the upper side opening portion 28 of the upper side member 23A also penetrates up and down, so thermal expansion or thermal contraction of the lighting film 24 can be tolerated even in the hole 25 and the upper side opening portion 28.

In the present embodiment, the lighting film 24 is configured to be coupled to the support member 23 via the insertion member 27, so it is possible to prevent the lighting film 24 from falling out of the support member 23.

In the present embodiment, by configuring the width of the upper side opening portion 28 and the lower groove 15 to satisfy Relationship (1) described above, the same effects as those of the previous embodiment can be obtained.

Note that there may be at least one point at which the lighting film 24 is suspended, but a plurality of points may be provided depending on the size and the like of the lighting film 24. Because the upper side member 23A of the support member 23 is provided with the upper side opening portion 28 that penetrates up and down, the lighting film 24 is easily held horizontally by providing two or more hanging points.

### Third Embodiment

Next, a configuration of a third embodiment of a lighting unit will be described.

The basic configuration of a lighting unit 30 of the present embodiment described below is substantially the same as that of the second embodiment described above, but the configuration of the lower side member of the support member differs from that of the second embodiment.

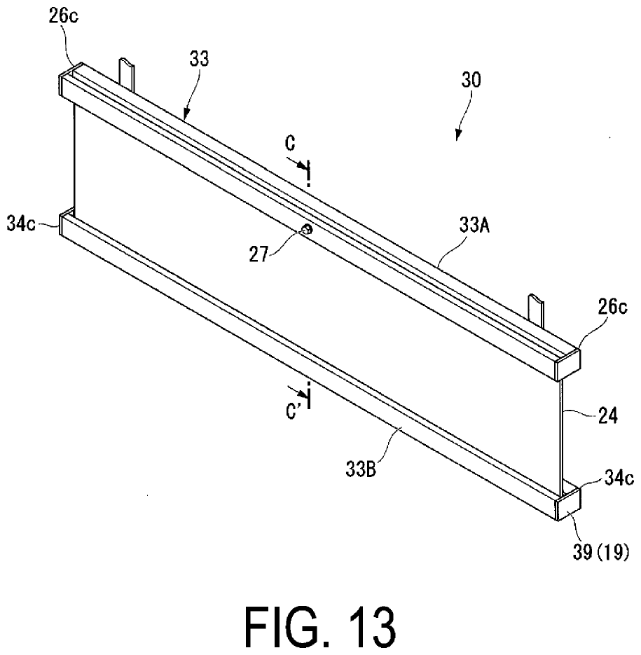

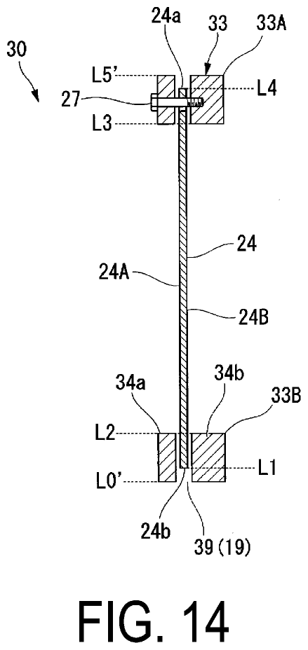

FIG. 13 is a perspective view of the lighting unit 30 according to the third embodiment. FIG. 14 is a cross-sectional view taken along line C-C′ of FIG. 13.

As illustrated in FIG. 13 and FIG. 14, the lighting unit 30 of the present embodiment includes a support member 33 having at least an upper side member 33A provided along the upper side 24a of the lighting film 24 and a lower side member 33B provided along the lower side 24b of the lighting film 24, and suspends and holds the lighting film 24. The upper side member 33A is the same as the configuration of the upper side member of the second embodiment.

The lower side member 33B is formed by a first support portion 34a disposed opposite the light incident surface 24A of the lighting film 24, a second support portion 34b disposed opposite the light emission surface 24B, and a pair of coupling members 34c and 34c that connect both end sides of the first support portion 34a and the second support portion 34b. The lower side member 33B has a lower side opening portion 39 that penetrates up and down and through which the lower side 24b of the lighting film 24 is inserted. Because the lower side opening portion 39 penetrates up and down, the lower side opening portion 39 functions as a stretch allowance portion 19 that allows thermal expansion and contraction of the lighting film 24.

In FIG. 14, the lower surface 33b of the lower side member 33B is set as the reference position L0′, and L1, L2, L3, L4, and L5′ are the same as in FIG. 6. In the present embodiment, the lighting film 24 in a state in which thermal contraction has not occurred is held in the support member 33 at a position where the lower side 24b is in L0′≤L1 with respect to the lower side member 33B, and a position where the upper side 24a is in L4≤L5 with respect to the upper side member 33A.

In the present embodiment, by providing the lower side opening portion 39 that penetrates up and down in the lower side member 33B, the lower side 24b does not project against the lower side member 33B regardless of the expansion ratio of the lighting film 24. The lower side opening portion 39 functions as the stretch allowance portion 19 to ensure the degree of freedom of stretching of the lighting film 24 suspended and housed within the support member 33. As a result, similar to the above-described embodiment, even in a case where thermal expansion or thermal contraction occurs in the lighting film 24, no external force is applied from the support member 33, and warping or deformation can be prevented.

In the present embodiment as well, by configuring the width of the upper side opening portion 38 and the lower side opening portion 39 to satisfy Relationship (1) described above, the same effects as those of the previous embodiment can be obtained.

In the present embodiment, since the upper and lower sides of the support member 23 are open, the mounting position of the lighting film 24 with respect to the support member 33 can be appropriately changed in the vertical direction because the upper side 24a and the lower side 24b of the lighting film 24 do not project against the support member 33 in the vertical direction.

Next, several embodiments will be described in which the mounting position of the lighting film 24 with respect to the support member 33 is varied. The basic configurations of the lighting unit according to the fourth to sixth embodiments illustrated below are substantially the same as that of the third embodiment, but the mounting position of the lighting film 24 with respect to the support member 33 differs from the third embodiment.

### Fourth Embodiment

First, a configuration of a fourth embodiment of a lighting unit 40 will be described.

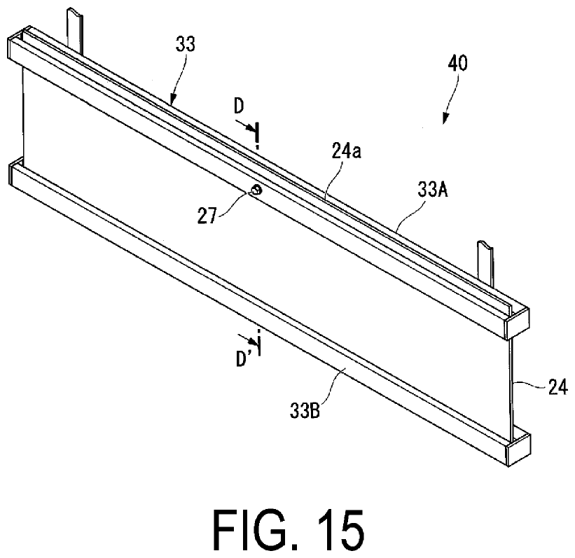

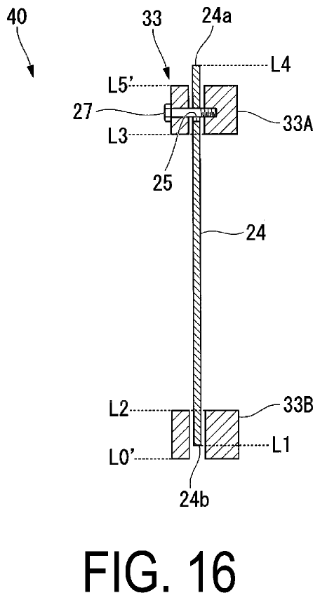

FIG. 15 is a perspective view of the lighting unit 40 according to the fourth embodiment. FIG. 16 is a cross-sectional view taken along line D-D′ of FIG. 15.

As illustrated in FIGS. 15 and 16, in the present embodiment, the lighting film 24 is suspended and held in a state (L5′<L4) in which the upper side 24a protrudes upward from the upper side member 33A with respect to the support member 33. The lower side 24b of the lighting film 24 is located above the reference position L0′ or at the same position as the reference position L (L0′≤L1). The mounting position of the lighting film 24 with respect to the support member 33 can be adjusted by changing the position of the hole 25 of the lighting film 24.

As in the present embodiment, even in a configuration in which the upper side 24a of the lighting film 24 is held so as to protrude upward from the upper side member 33A, the same effects as those of the previous embodiment can be obtained.

### Fifth Embodiment

Next, a configuration of a fifth embodiment of a lighting unit 50 will be described.

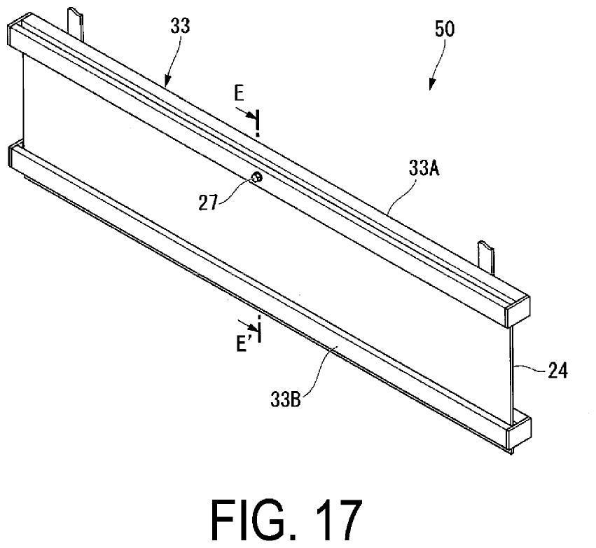

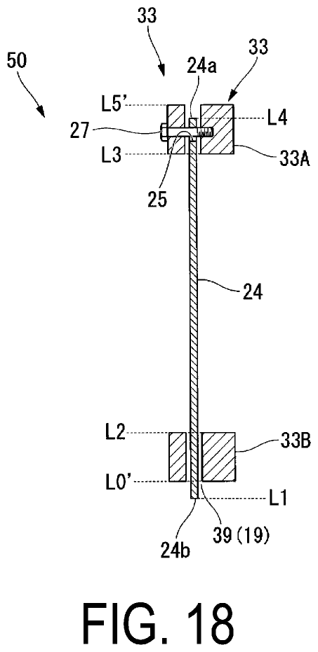

FIG. 17 is a perspective view of the lighting unit 50 according to the fifth embodiment. FIG. 18 is a cross-sectional view taken along line E-E′ of FIG. 17.

As illustrated in FIGS. 17 and 18, in the present embodiment, the lighting film 24 is suspended and held in a state (L1<L0′) in which the lower side 24b protrudes downward from the lower side member 33B with respect to the support member 33. However, in the above-described relationship, as in the present embodiment, in a case where any position is below the reference position L0′, then the distance L1 is set to a negative value. The upper side 24a of the lighting film 24 is located below the upper surface 33a of the upper side member 33A or at the same position as the reference position L (L4≤L5′).

As in the present embodiment, even in a configuration in which the lower side 24b of the lighting film 24 protrudes downward from the lower side member 33B and keeps this state, the same effects as those of the previous embodiment can be obtained.

### Sixth Embodiment

Next, a configuration of a sixth embodiment of a lighting unit 60 will be described.

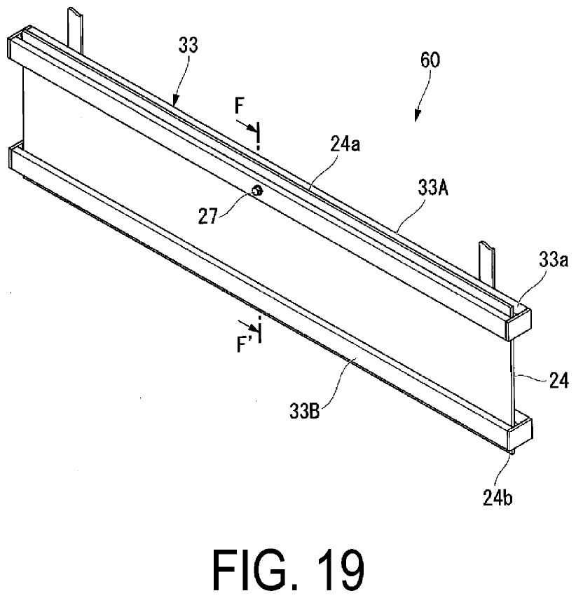

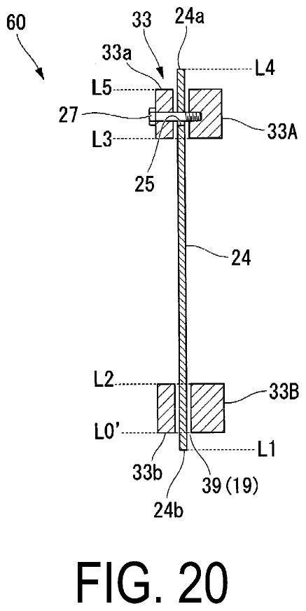

FIG. 19 is a perspective view of the lighting unit 60 according to the sixth embodiment. FIG. 20 is a cross-sectional view taken along line F-F′ of FIG. 19.

As illustrated in FIGS. 19 and 20, in the present embodiment, with respect to the support member 33, the lighting film 24 is suspended and held in a state (L1<L0′, L5′<L4) in which the upper side 24a and the lower side 24b are respectively vertically protruding from the upper surface 33a and the lower surface 33b of the support member 33.

As in the present embodiment, even in a configuration in which the upper and lower sides of the lighting film 24 are respectively protruding from the upper side member 33A or the lower side member 33B, the same effects as those of the previous embodiment can be obtained.

### Seventh embodiment

Next, a configuration of a seventh embodiment of a lighting unit 70 will be described.

The basic configuration of the lighting unit 70 of the present embodiment described below is substantially the same as that of the first embodiment, but the configuration of the support member differs from that of the first embodiment.

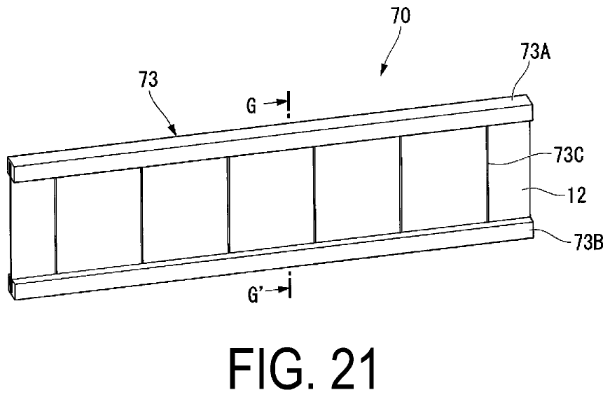

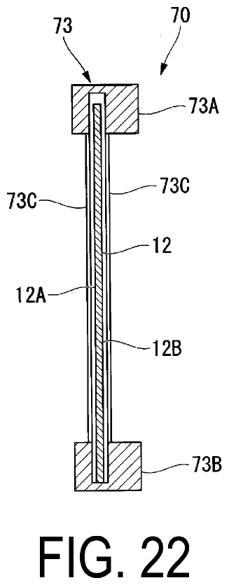

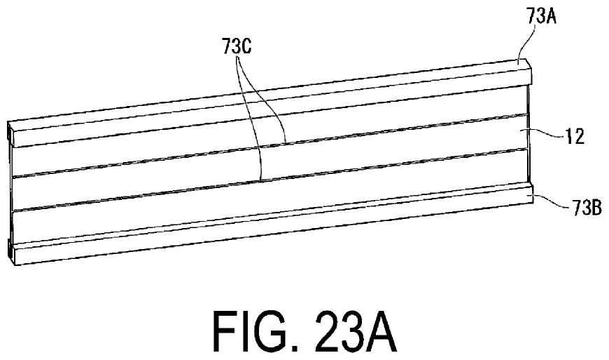

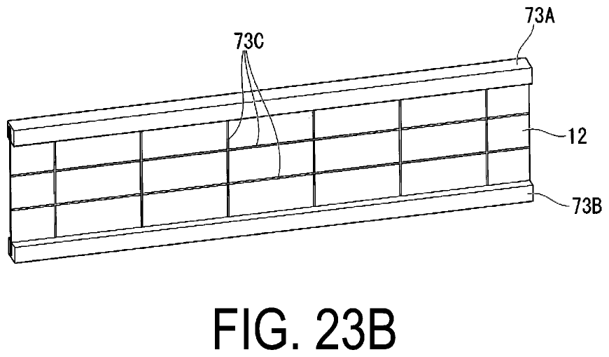

FIG. 21 is a perspective view of the lighting unit 70 according to the seventh embodiment. FIG. 22 is a cross-sectional view taken along line G-G′ of FIG. 21. FIG. 23A is a perspective view illustrating a configuration in which pressing members 73C are provided so as to extend in a horizontal direction. FIG. 23B is a perspective view illustrating a configuration in which pressing members 73C are provided so as to intersect in the horizontal direction and the vertical direction.

As illustrated in FIGS. 21 and 22, the lighting unit 70 of the present embodiment includes a support member 73 having an upper side member 73A, a lower side member 73B, and narrow rod-shaped pressing members 73C extending in the vertical direction between the upper side member 73A and the lower side member 73B. The upper side member 73A and the lower side member 73B are the same as the configurations of the first embodiment.

The pressing members 73C are disposed facing each of the light incident surface 12A and the light emission surface 12B in the exposed portion of the lighting film 12 exposed from the support member 23. Acrylic bars, for example, are used as the pressing members 73C. The pressing members 73C preferably have a higher rigidity than the lighting film 12 and have light transmittance.

In the present embodiment, six of the pressing members 73C are provided at predetermined intervals in the horizontal direction, but the number and arrangement intervals of the pressing members 73C are set as appropriate in accordance with the size of the lighting film 12. The pressing member 73C disposed on the light incident surface 12A side of the lighting film 12 and the pressing member 73C disposed on the light emission surface 12B side are disposed facing each other via the lighting film 12, but may be arranged so as to be offset from each other. The cross-sectional shape of the pressing members 73C is not particularly limited. For example, the shape may be a circle, an ellipse, a triangle, a square, or the like.

According to the present embodiment, the two sides of the lighting film 12 in the thickness direction are locally sandwiched by the plurality of pressing members 73C, and thus a structure is obtained in which deflection of the lighting film 12 is further suppressed. In particular, this is effective because overall deflection can be further suppressed, such as in a case where the lighting film 12 is increased in area.

The extension direction of the pressing member 73C is not limited to a vertical direction. For example, as illustrated in FIG. 23A, the plurality of horizontally extending pressing members 73C may be provided at intervals in the vertical direction, or as illustrated in FIG. 23B, the plurality of pressing members 73C may be provided in a lattice shape so as to extend in the vertical direction and the horizontal direction, respectively.

Note that the pressing structure of the present embodiment can be used in other embodiments described above.

### Eighth Embodiment

Next, a configuration of an eighth embodiment of a lighting unit will be described.

The basic configuration of the lighting unit 80 described below is substantially the same as that of the first embodiment described above, but differs from the first embodiment in that the lighting unit 80 includes protective sheets 81 of the lighting film 12.

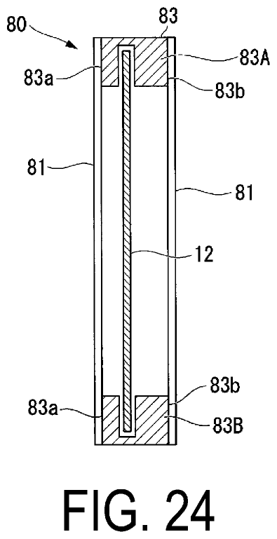

FIG. 24 is a cross-sectional view of the lighting unit 80 according to the eighth embodiment.

As illustrated in FIG. 24, the lighting unit 80 of the present embodiment is configured with a lighting film 12, a support member 83, and a pair of protective sheets 81 and 81. The support member 83 is the same as the configuration of the first embodiment.

One protective sheet 81 is provided on the window side of the support member 83 and is bonded to the front surfaces 83a and 83a of the upper side member 83A and the lower side member 83B via adhesive tape (not illustrated) or the like. The other protective sheet 81 is provided on the indoor side of the support member 83, and is bonded to the rear surfaces 83b and 83b of the upper side member 83A and the lower side member 83B via adhesive tape (not illustrated) or the like.

The protective sheets 81 are made of a highly transparent material. The protective sheets 81 have a larger area than the exposed portion of the lighting film 12 and covers the entire exposed portion.

As in the present embodiment, by providing the protective sheets 81, it is possible to prevent scratches and dirt from being attached to the lighting film 12. Flame resistance as the lighting device 1 can be increased by using a flame retardant, non-flammable protective sheet 81.

Note that the technical scope of the present invention is not limited to the embodiments described above, and various modifications can be made without departing from the spirit of the present invention.

For example, an example of a configuration is described in which the thickness of the support member 13 is thinner on the window side than the indoor side, but the thicknesses may be the same as each other.

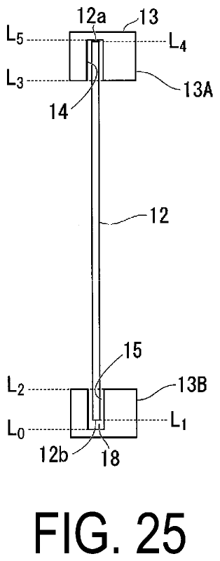

As long as the support member 13 is provided with a stretch allowance portion, a configuration is also conceivable in which the side end surface of the lighting film 12 is fixed to and supported by the support member 13. FIG. 25 is a cross-sectional view illustrating a modified example of the support structure. For example, as illustrated in FIG. 25, a method of fixing the lighting film 12 to the bottom portion of the upper groove 14 of the upper side member 13A with an adhesive tape or the like not illustrated is described. At this time, the end surface along the upper side 12a of the lighting film 12 is bonded to the bottom portion of the upper groove 14 by an adhesive material not illustrated or the like, and the light incident surface 12A and the light emission surface 12B side of the lighting film 12 are not adhered to the support member 13. By setting the arrangement interval between the upper side member 13A and the lower side member 13B such that the positional relationship of each member is in L0<L1<L2<L3<L4=L5, the lower side 12b side of the lighting film 12 is held in a floating state in the lower groove 15. The gap created between the lower side 12b and the bottom portion of the lower groove 15 functions as a stretch allowance portion 18.

In this manner, by fixing only the side end surface of the upper side 12a of the lighting film 12 and freeing the lower side 12b side with the stretch allowance portion 18, the lighting film 12 is able to expand and contract in the planar direction of the lighting film 12, and it is possible to alleviate the occurrence of warping and wrinkles accompanying stretching of the film in the stretch allowance portion 18.

### Ninth Embodiment

The lighting devices 1 of the first to eighth embodiments have configurations in which the lighting film 12 or 24 is supported mainly on the sides of the two ends in the vertical direction of the lighting film 12 or 24. The present embodiment is configured to support the lighting film 12 or 24 on the sides of the two ends in the horizontal direction of the lighting film 12 or 24.

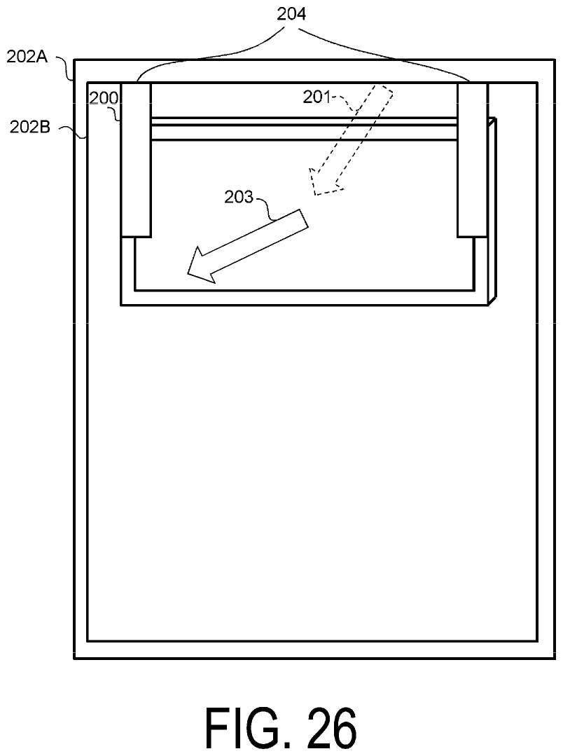

FIG. 26 illustrates a configuration of a lighting device 200 according to the present embodiment. In the lighting device 200, two sides of the ends in the horizontal direction of the lighting unit 210 are connected to the panel frame 202A by the coupling members 204. The panel frame 202A is a frame for fixing a panel 202B, which is a plate shaped glass, resin, or the like having translucency used in windows of buildings, vehicles, and the like.

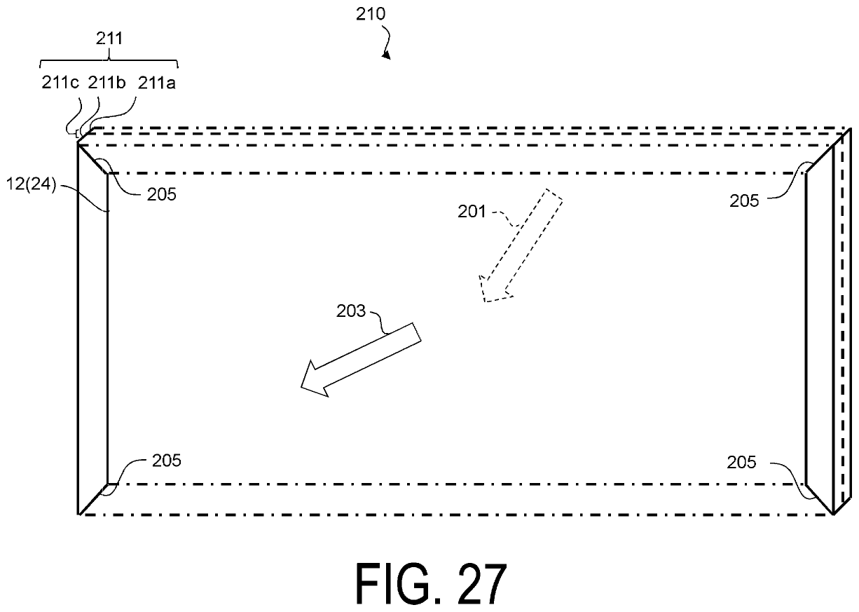

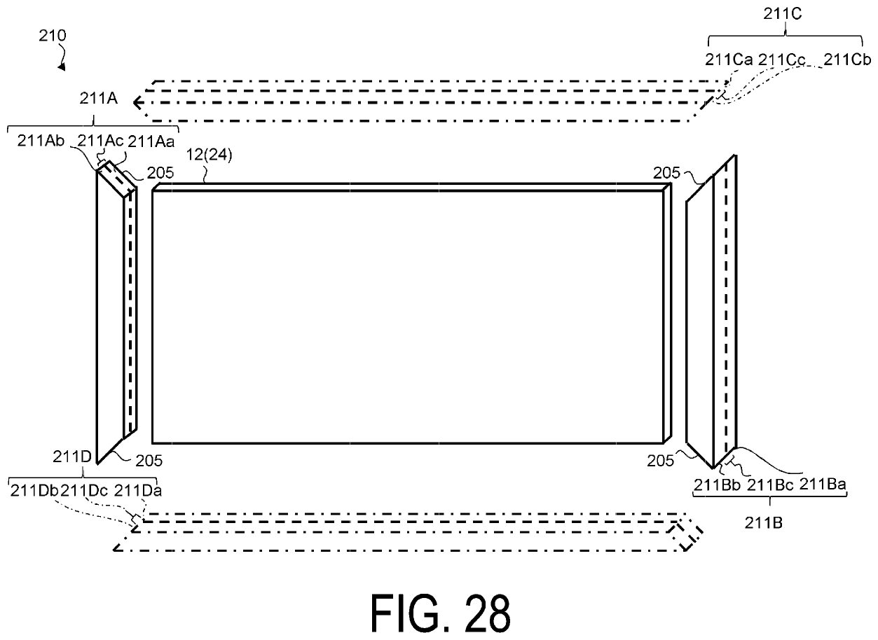

FIGS. 27 and 28 illustrate the configuration of the lighting unit 210. The lighting unit 210 includes a lighting film 12 or 24 that has a first surface and a second surface, and exits an incident light 1, which is, for example, light entering the first surface from the outdoor, out of the second surface opposite to the first surface toward a predetermined direction within the room as an emission light 3.

As illustrated in FIG. 27, the lighting unit 210 is provided with a support member 211 including a first support portion 211a disposed opposite the first surface, a second support portion 211b disposed opposite the second surface, and a groove 211c that houses an end portion of the lighting film 12 or 24.

In a case where the groove 211c is not provided, the lighting film 12 or 24 is sandwiched by a movement suppressing portion 213 provided in the first support portion 211a and the second support portion 211b. In a case where the groove 211c is not provided, the movement suppressing portion 213 described below serves as a cushioning material, and pressure greater than or equal to a predetermined value can be prevented from being applied to the lighting film 12 or 24.

Because the support member 211 supports the lighting film 12 or 24 without adhering, it is possible to reduce the occurrence of wrinkles or warping originating from the adhering portion.

In the lighting unit 210, as illustrated in FIG. 28, the support member 211 constituted by side portion support members 211A and 211B, an upper portion support member 211C, and a lower portion support member 211D supports the lighting film 12 or 24.

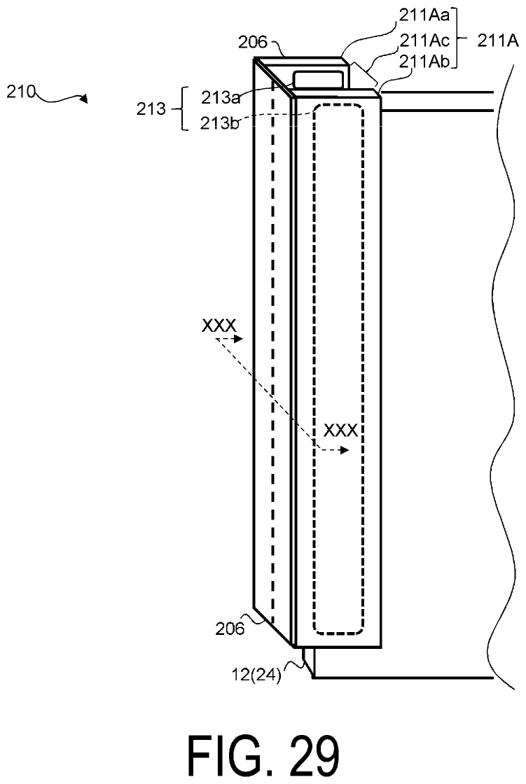

The junctions between the side portion support member 211A and 211B and the upper portion support member 211C (lower portion support member 211D) are an oblique delimiter as illustrated in delimiter portions 205 in FIGS. 27 and 28. Note that the horizontal delimiters may be formed as illustrated in delimiter portions 206 in FIG. 29, which will be described later.

The side portion support member 211A includes a first support portion 211Aa, a second support portion 211Ab, and a groove 211Ac. The side portion support member 211B includes a first support portion 211Ba, a second support portion 211Bb, and a groove 211Bc.

Similarly, the upper portion support member 211C includes a first support portion 211Ca, a second support portion 211Cb, and a groove 211Cc. The lower portion support member 211D includes a first support portion 211Da, a second support portion 211Db, and a groove 211Dc.

As illustrated in FIGS. 27 and 28, the first support portion 211a includes the first support portions 211Aa, 211Ba, 211Ca, and 211Da, and the second support portion 211b includes the second support portions 211Ab, 211Bb, 211Cb, 211Db.

Note that in FIG. 26, the lighting unit 210 is provided with the upper portion support member 211C and the lower portion support member 211D, but as indicated by the dotted lines in FIGS. 27 and 28, the upper portion support member 211C and the lower portion support member 211D are not necessarily required.

In the case where the upper portion support member 211C and the lower portion support member 211D are not present, the lighting film 12 or 24 is supported by the side portion support member 211A and 211B. Conversely, the upper portion support member 211C and the lower portion support member 211D may support the lighting film 12 or 24, and in this case, the side portion support members 211A and 211B are not necessary.

In a case where the side portion support members 211A and 211B and the upper portion support member 211C and the lower portion support member 211D are used in combination, the upper portion support member 211C and the lower portion support member 211D may use the same support members 13, 23, 33, and 73 as the above-described first to eighth embodiments.

FIG. 29 is a schematic view illustrating a main portion of the lighting unit 210 according to the present embodiment. A movement suppressing portion 213 is provided on the side portion support member 211A for suppressing movement of the lighting film 12 or 24 due to elongation or contraction caused by changes in the thermal environment and the like.

Note that the side portion support member 211B has the same configuration as the side portion support member 211A, and thus descriptions thereof will be omitted.

The movement suppressing portion 213 is made of a material having a lower Young's modulus than the side portion support member 211A in order to suppress movement of the lighting film 12 or 24, and is, for example, rubber, silicon, urethane, sponge, or the like. The movement suppressing portion 213 is preferably an elastic body such as rubber from the perspective of not only absorbing and suppressing movement of the lighting film 12 or 24, but also suppressing movement by elasticity.

The movement suppressing portion 213 is made of a material having a Young's modulus that is lower than that of the side portion support member 211A, and follows the stretching of the lighting film 12 or 24 in a case of being in contact with the lighting film 12 or 24. As a result, it is possible to reduce the occurrence of wrinkles or warping in the lighting film 12 or 24.

The movement suppressing portion 213 is constituted by a first movement suppressing portion 213a and a second movement suppressing portion 213b. the first movement suppressing portion 213a is provided on the first support portion 213Aa, and the second movement suppressing portion 213b is provided on the second support 213Ab.

The first movement suppressing portion 213a is provided on the entire surface between the lighting film 12 or 24 and the first support portion 211Aa, and uniformly contacts the lighting film 12 or 24 over the entire surface. Similarly, the second movement suppressing portion 213b is provided on the entire surface between the lighting film 12 or 24 and the second support portion 211Ab, and uniformly contacts the lighting film 12 or 24 over the entire surface.

The movement suppressing portion 213 is provided on the entire surface of both surfaces of the surfaces of the side portion support member 211A facing the lighting film 12 or 24, and can uniformly follow the stretching of the lighting film 12 or 24 by uniformly contacting the lighting film 12 or 24 over the entire surface.

Note that in a case where the support member 13, 23, 33, or 73 is used in conjunction with the side portion support members 211A and 211B, the movement suppressing portion 213 may be provided on the support member 13, 23, 33, or 73.

In the present embodiment, the movement suppressing portion 213 is preferably provided on the side portion support member 211A, but this is not necessary.

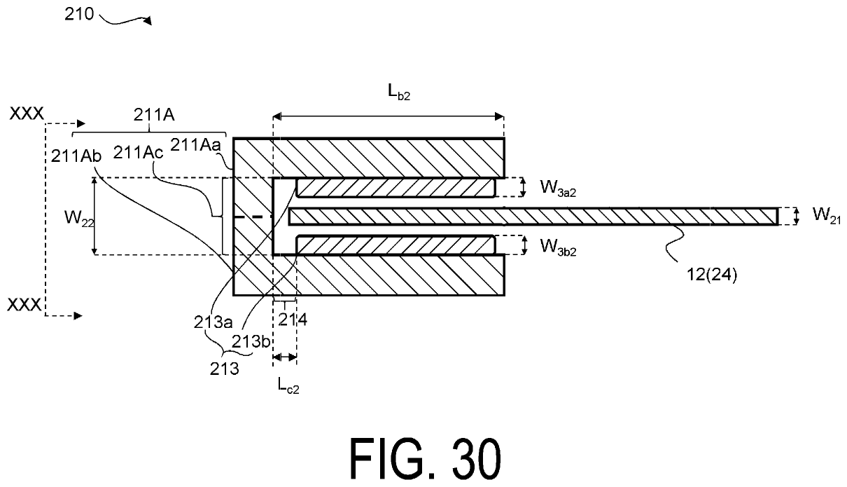

As illustrated in the cross-sectional view taken along XXX-XXX of FIG. 29 in FIG. 30, the side portion support member 211A is provided with a stretch allowance portion 214 that allows elongation or shrinkage associated with changes in the thermal environment of the lighting film 12 or 24 and the like.

The stretch allowance portion 214 is a gap portion between the lighting film 12 or 24 and the side portion support member 211A, and the expansion and contraction of the lighting film 12 or 24 is allowed, so it is possible to prevent external force from being applied to the lighting film 12 or 24 in a case where the lighting film 12 or 24 stretches.

In a case where the thickness of the lighting film 12 or 24 is W21, the thickness of the first movement suppressing portion 213a is W3a2, the thickness of the second movement suppressing portion 213b is W3b2, the width of the groove 211Ac is W22, and the depth of the groove 211Ac is Lb2, it is desirable for the lighting unit 210 to satisfy Relationship (2) below.

Lb2*tan 5°+W21*cos 5°≥W22−(W21+W3a2+W3b2)≥0 (2)

In a case where Relationship (2) is satisfied, the lighting unit 210 can suppress deflection and also suppress a phenomenon that affects the appearance of the lighting film 12 or 24, such as color cracking or glare.

As described above, the lighting unit 210 according to the present embodiment is provided with the stretch allowance portion 214, and therefore allows elongation or shrinkage associated with changes in the thermal environment of the lighting film 12 or 24 and the like. Furthermore, in a case where the movement suppressing portion 213 is provided, the lighting film 12 or 24 is prevented from moving due to elongation or contraction caused by changes in the thermal environment and the like.

Note that in the present embodiment, the lighting film 12 or 24 is supported by the side portion support members 211A and 211B. The present invention is not limited thereto, and the upper portion support member 211C and the lower portion support member 211D may have the same configuration as the side portion support member 211A, and the lighting film 12 or 24 may be supported by the upper portion support member 211C and the lower portion support member 211D. In a case of supporting the lighting film 12 or 24 by the upper portion support member 211C and the lower portion support member 211D, the effects are the same as the case of supporting the lighting film 12 or 24 by the side portion support members 211A and 211B.

The lighting device 200 of the present embodiment is assumed to be applied to 202B provided vertically in the vertical direction as in FIG. 29, but may also be applied to a panel provided horizontally in the horizontal direction, such as a roof window.

### Tenth Embodiment

In the ninth embodiment, in the case where the movement suppressing portion 213 is provided, the movement suppressing portion 213 is provided on the entire surface of both sides of the surfaces of the side portion support member 211A facing the lighting film 12 or 24 and is uniformly in contact with the lighting film 12 or 24 on the entire surface of the movement suppressing portion 213. According to the present embodiment, the movement suppressing portion 213 is not limited to the case where the movement suppressing portion 213 is uniformly in contact with the entire surface, but the movement suppressing portion 213 and the lighting film 12 or 24 may come into contact with each other by a protrusion portion provided on the movement suppressing portion 213.

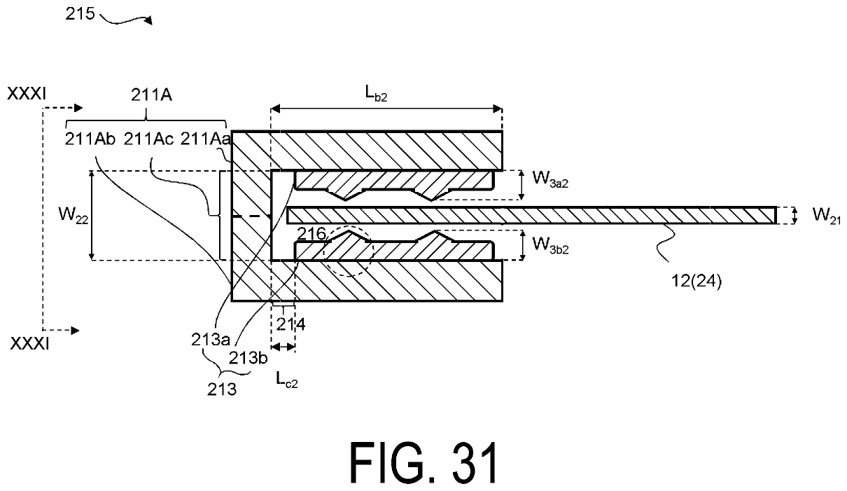

FIG. 31 illustrates a cross-sectional view of a lighting unit 215 according to the present embodiment. As illustrated in FIG. 31, protrusion portions 216 are provided on both sides of the lighting film 12 or 24 in the movement suppressing portion 213 of the present embodiment. The protrusion portion 216 is provided to reduce the contact area in a case where the movement suppressing portion 213 comes into contact with the lighting film 12 or 24.

In order to reduce the contact area between the movement suppressing portion 213 and the lighting film 12 or 24 by the protrusion portion 216, the movement suppressing portion 213 can follow the stretching of the lighting film 12 or 24 even in a case where the expansion and contraction of the lighting film 12 or 24 is large compared with the ninth embodiment.

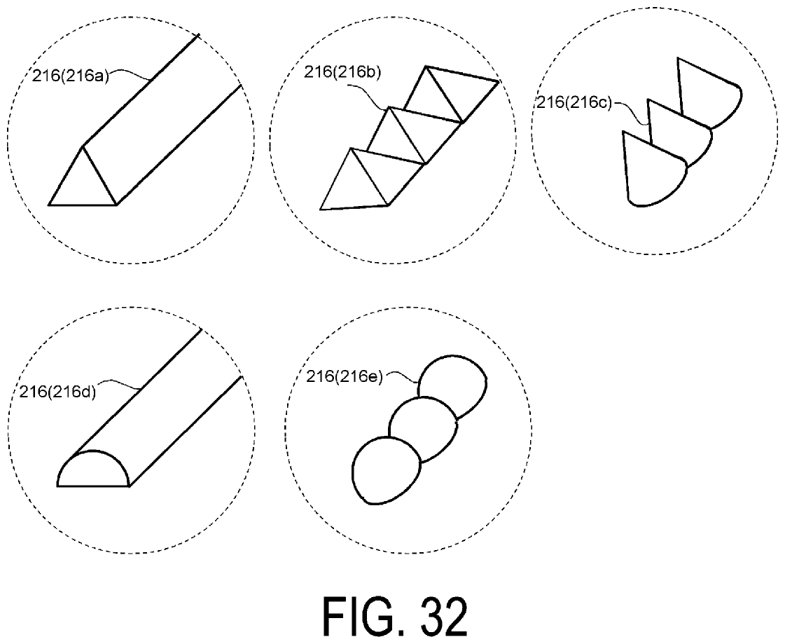

As illustrated in FIG. 32, the protrusion portion 216 may be a ridge portion that is in contact with the lighting film 12 or 24 in line and may be provided so as to extend in the vertical direction. The ridge portion may be a triangular prism, such as a protrusion portion 216a, or a half cylinder like a protrusion portion 216d, for example.

As illustrated in the enlarged view of the protrusion portion 216 in FIG. 32, the protrusion portion 216 may be provided as protruding portions that are in contact with the lighting film 12 or 24 at points and are arranged in a vertical direction. The protruding portions may be pyramids such as quadrangular pyramids and cones, such as the protrusion portion 216b and 216c, or half spheres such as 216e.

As described above, the shape of the protrusion portion 216 has a shape in which the area on the upper surface of the lighting film 12 or 24 side is narrower than the bottom surface on the side portion support member 211A side, and damage to the protrusion portion 216 is less likely to occur while reducing the contact area with the lighting film 12 or 24.

Note that the lighting unit 215 preferably also satisfies Relationship (2) described above. Note that in Relationship (2), the thickness including in the protrusion portion 216 of the first movement suppressing portion 213a is W3a2, and the thickness including in the protrusion portion 216 of the second movement suppressing portion 213b is W3b2. In the present embodiment as well, in a case where Relationship (2) is satisfied, the lighting unit 215 can suppress deflection and also suppress the phenomenon of affecting the appearance of the lighting film 12 or 24 such as color cracking or glare.

As described above, in a case of contacting the lighting film 12 or 24, the protrusion portion 216 reduces the contact area between the movement suppressing portion 213 and the lighting film 12 or 24 as compared to the ninth embodiment, and it is possible to absorb the stretchable portion by a location not in contact in a case where the lighting film 12 or 24 expands and contracts. Therefore, in addition to the effects of the ninth embodiment, the lighting unit 215 according to the present embodiment can follow the stretching of the lighting film 12 or 24 even in a case where the expansion and contraction of the lighting film 12 or 24 is greater than that of the ninth embodiment.

### Eleventh Embodiment

In the ninth and tenth embodiments, the case has been described in which the movement suppressing portion 213 is provided by using a material separate from the side portion support member 211A in the side portion support member 211A. According to the present embodiment, the embodiment is not limited to the case where the movement suppressing portion 213 is provided in the side portion support member 211A by using a material separate from the side portion support member 211A, and a portion of the lighting film 12 or 24 may be bent to achieve the same effect as the movement suppressing portion 213.

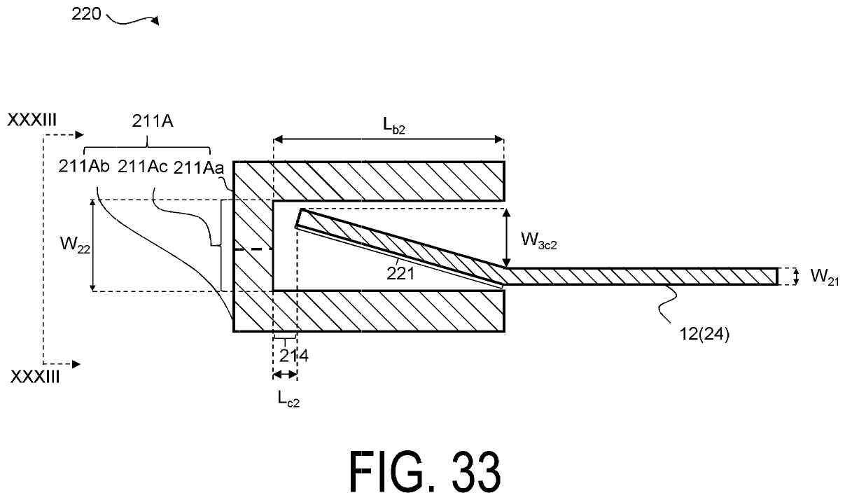

FIG. 33 illustrates a cross-sectional view of the lighting unit 220 of the present embodiment. As illustrated in FIG. 33, the lighting film 12 or 24 of the present embodiment is provided with a bent portion 221 by performing a bending process on one location of the lighting film 12 or 24.

From the perspective of the used material at the site where movement is suppressed, it is possible to make the lighting film 12 or 24 less likely to have wrinkles or warping generated due to elongating or shrinking of the lighting film 12 or 24 as a result of the change in the thermal environment or the like, as compared to the ninth and tenth embodiments. Because the bent portion 221 is a portion of the lighting film 12 or 24, wrinkles or warping can be less likely to occur compared to the ninth and tenth embodiments from the perspective of the used material at the site where movement is suppressed. Note that the side where movement is suppressed is the bent portion 221 in the present embodiment, and is the movement suppressing portion 213 in the ninth and tenth embodiments.

The lighting unit 220 desirably satisfies Relationship (3) below in a case where the thickness of the lighting film 12 or 24 is W21, the bending thickness of the bent portion is W3c2, the width of the groove 211Ac is W22, and the depth of the groove 211Ac is Lb2.

Lb2*tan 5°+W21*cos 5°≥W22−(W21+W3c2)≥0 (3)

In a case where Relationship (3) is satisfied, the lighting unit 220 can suppress deflection and also suppress a phenomenon that affects the appearance of the lighting film 12 or 24, such as color cracking or glare.

As described above, in addition to the effects of the ninth embodiment, the lighting unit 220 according to the present embodiment uses the same used material at the site where movement is suppressed as the lighting film 12 or 24, so it is possible to make wrinkles and warping of the lighting film 12 or 24 less likely to occur than the ninth and tenth embodiments.

### Twelfth Embodiment

In the ninth and tenth embodiments, in the case where the movement suppressing portion 213 is provided, the movement suppressing portion 213 is provided on the entire surface of both sides of the surfaces of the side portion support member 211A facing the lighting film 12 or 24, and is uniformly in contact with the lighting film 12 or 24 on the entire surface of the movement suppressing portion 213.

According to the present embodiment, the movement suppressing portion 213 is not limited to being provided on the entire surface of both sides of the surfaces of the side portion support member 211A facing the lighting film 12 or 24, and as described later, a movement suppressing portion 226 may be provided on a portion of both sides of the surfaces of the side portion support member 211A facing the lighting film 12 or 24.

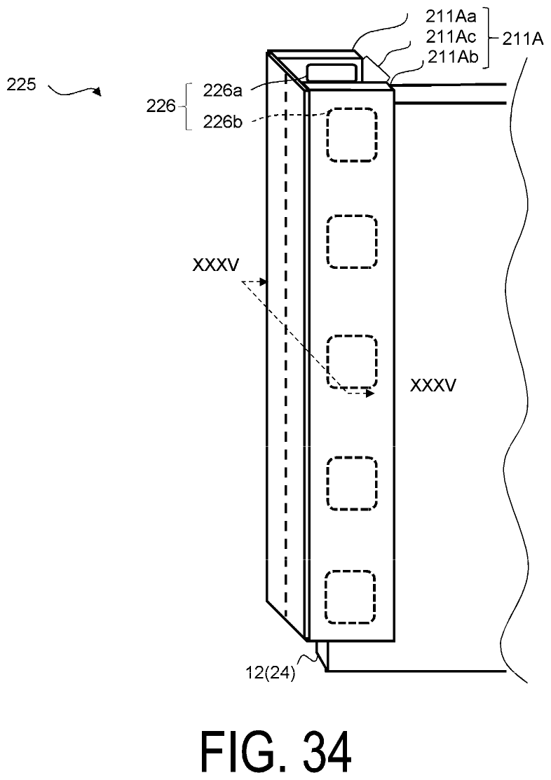

FIG. 34 is a schematic view illustrating a main portion of a lighting unit 225 according to the present embodiment. As illustrated in FIG. 34, in the lighting unit 225 of the present embodiment, a movement suppressing portion 226 is provided on a portion of both sides of surfaces of the side portion support member 211A facing the lighting film 12 or 24. The movement suppressing portion 226 is constituted by a movement suppressing portion 226a provided on the first support portion 211Aa and a movement suppressing portion 226b provided on the second support portion 211Ab.

As described above, the movement suppressing portion 226 is provided on a portion of both sides of surfaces of the side portion support member 211A facing the lighting film 12 or 24, and it is possible to absorb the stretching portion in a case where the lighting film 12 or 24 is stretched in a location where the movement suppressing portion 226 is not provided. Therefore, in addition to the effects of the ninth embodiment, the lighting unit 225 according to the present embodiment can follow the stretching of the lighting film 12 or 24 even in a case where the expansion and contraction of the lighting film 12 or 24 is greater than that of the ninth embodiment.

### Other Embodiments

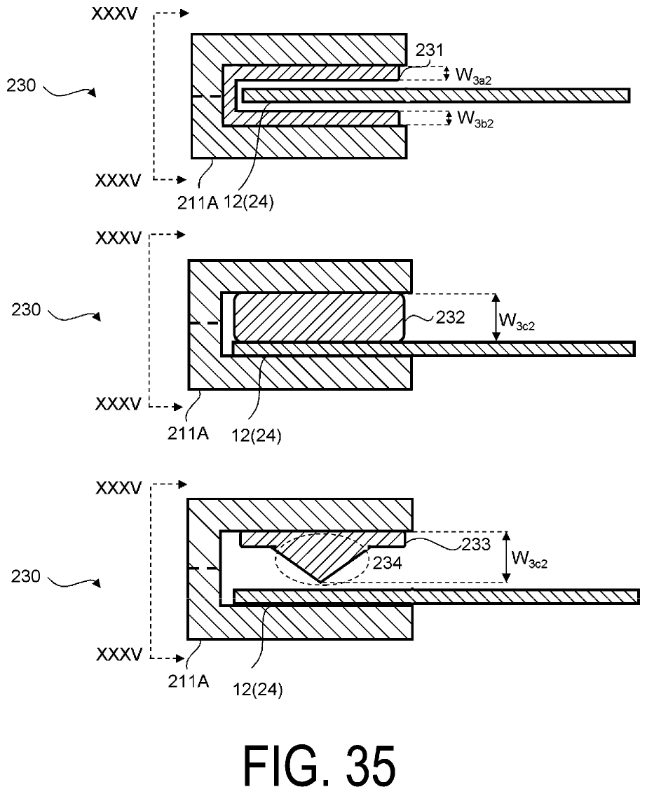

In the ninth embodiment, the stretch allowance portion 214 is a gap portion, but the same effects as those of the ninth embodiment can be obtained even in a case where the movement suppressing portion 231 is portion of a stretch allowance portion 214, as illustrated in the cross-sectional view of a lighting unit 230 in FIG. 35. Note that in a case where the movement suppressing portion 231 is a portion of the stretch allowance portion 214, the lighting unit 230 desirably satisfies Relationship (2) above.

Since the movement suppressing portion 231 has a lower Young's modulus than the side portion support member 211A, the lighting film 12 or 24 is pressed into the movement suppressing portion 231 that is portion of the stretch allowance portion 214 in a case where the lighting film 12 or 24 expands due to a thermal environment or the like. Because the lighting film 12 or 24 is pressed into the movement suppressing portion 231 that is portion of the stretch allowance portion 214, it is possible to make it difficult to generate deflection of the lighting film 12 or 24.

In the ninth embodiment, the movement suppressing portion 213 is provided on both sides of the lighting film 12 or 24, but the same effects as those of the ninth embodiment can be obtained even in a case where the movement suppressing portion 232 is provided on one side as illustrated in FIG. 35. Note that in a case where the movement suppressing portion 232 is provided on one side, the lighting unit 230 desirably satisfies Relationship (3) above.

In the tenth embodiment, the movement suppressing portion 213 and the protrusion portion 216 are provided on both sides of the lighting film 12 or 24, but the same effects as those of the tenth embodiment can be obtained even in a case where the movement suppressing portion 233 and the protrusion portion 234 are provided on one side as illustrated in FIG. 35. Note that in a case where the movement suppressing portion 233 and the protrusion portion 234 are provided on one side, the lighting unit 230 desirably satisfies Relationship (3) above.

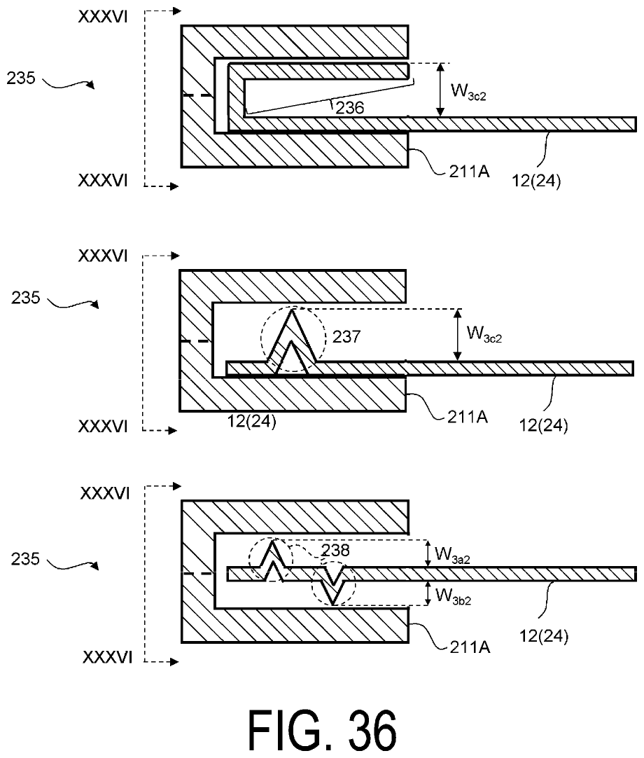

In the eleventh embodiment, bending processing is performed at one location, but bending may be performed at two locations as illustrated in the bent portions 236 and 237 in the cross-sectional view of the lighting unit 235 in FIG. 36, or bending may be performed at four locations as illustrated by the bent portion 238. The same effects as those of the eleventh embodiment can also be obtained in a case where bending is performed at two or more locations. In a case where the bent portion 236 or 237 is provided, the lighting unit 235 desirably satisfies Relationship (3), and in a case where the bent portion 238 is provided, the lighting unit 235 desirably satisfies Relationship (2).

In the tenth embodiment, the movement suppressing portion 213 is a different material than the side portion support member 211A, but the same effects as those of the tenth embodiment can also be obtained with the same material as the side portion support member 211A.

The same effects as those of the eleventh embodiment can be obtained even in a case where the bent portion 221 is provided only in portion of the end portion by providing notches in the accommodating end portion in the side portion support member 211A of the lighting film 12 or 24 in the eleventh embodiment.

Furthermore, in the embodiment described above, an example of a panel-type lighting device 1 or 200 is described, but, for example, a lighting device 1 such as a blind, a roll-screen type, or the like may be used.

In addition, the specific descriptions of the shapes, numbers, arrangements, materials, and the like of the components of the lighting member and the lighting device 1 or 200 can be changed as appropriate without limitation to the above-described embodiments.

### INDUSTRIAL APPLICABILITY

The present invention can be utilized in lighting devices for incorporating external light, such as sunlight, into a room.

1. A lighting device comprising:
a lighting film having a rectangular shape including a first surface and a second surface; and
a support member configured to support the lighting film on at least two opposite sides of four sides of the lighting film so that a first surface and a second surface are positioned substantially parallel to a vertical direction,
wherein the support member includes:
a first support portion disposed opposite the first surface;
a second support portion disposed opposite the second surface;
an own weight support portion supporting an own weight of the lighting film; and
a stretch allowance portion configured to allow elongation or shrinkage in a direction parallel to the first surface and the second surface of the lighting film due to a change in temperature.

2. The lighting device according to claim 1,
wherein the support member includes an upper side member provided along an upper side of the lighting film and a lower side member provided along a lower side of the lighting film,
the upper side member includes an upper groove into which an upper side of the lighting film is inserted,
the lower side member includes a lower groove into which a lower side of the lighting film is inserted,
the own weight support portion is constituted by a bottom portion of the lower groove or a bottom portion of the upper groove, and
the stretch allowance portion is constituted by a gap between the upper side of the lighting film and the bottom portion of the upper groove or a gap between the lower side of the lighting film and the bottom portion of the lower groove.

3. The lighting device according to claim 2,
wherein the lighting device satisfies Relationship (1) in a case where a thickness of the lighting film is denoted by W1, a width of the upper groove or the lower groove is denoted by W2, and a depth of the upper groove or the lower groove is denoted by Lb;
Lb*tan 5°+W1*cos 5°≥W2>W1 (1).

4. The lighting device according to claim 1,
wherein the support member includes an upper side member provided along an upper side of the lighting film and a lower side member provided along a lower side of the lighting film,
a hole is provided in a region on a side of the upper side of the lighting film,
the upper side member includes an upper side member main body and an insertion member inserted through the hole of the lighting film, and
the own weight support portion is constituted by the insertion member.

5. The lighting device according to claim 4,
wherein the lower side member includes a lower groove into which the lower side of the lighting film is inserted, and
the stretch allowance portion is constituted by a gap between the lower side of the lighting film and a bottom portion of the lower groove.

6. The lighting device according to claim 4,
wherein the lower side member includes a lower side opening portion penetrating up and down and into which the lower side of the lighting film is inserted, and
the stretch allowance portion is constituted by the lower side opening portion.

7. The lighting device according to claim 6,
wherein a screw hole penetrating in a horizontal direction is provided in the upper side member main body, and
the insertion member is constituted by the screw hole of the upper side member main body and a screw inserted through the hole of the lighting film.

8. The lighting device according to claim 2,
wherein, in the lighting film, a longitudinal dimension of an exposed portion exposed from the upper side member and the lower side member is greater than a total of a longitudinal dimension of an unexposed portion covered by the upper side member and the lower side member.

9. The lighting device according to claim 1, further comprising:
a suppressing member disposed opposite the first surface and the second surface in an exposed portion of the lighting film exposed from the support member, the suppressing member suppressing deflection of the lighting film.

10. The lighting device according to claim 1,
wherein the first support portion includes a first surface disposed opposite a window surface,
the second support portion includes a second surface disposed toward an indoor side, and
a distance from the first surface of the first support portion to the first surface of the lighting film is less than a distance from the second surface of the second support portion to the second surface of the lighting film.

11. The lighting device according to claim 1, further comprising:
at least one or more protective sheets supported by the support member and covering at least a portion of the first surface or at least a portion of the second surface of the lighting film.

12. A lighting device comprising:
a lighting film including a first surface for light to enter and a second surface that is opposed to the first surface and that emits the light of entry, the lighting film emitting the light of entry in a predetermined direction; and
a support member including a first support portion disposed opposite the first surface, a second support portion disposed opposite the second surface, and a stretch allowance portion configured to allow elongation or shrinkage of the lighting film due to a change in temperature.

13. The lighting device according to claim 12,
wherein the stretch allowance portion is a gap portion between the support member and the lighting film.

14. The lighting device according to claim 12,
wherein the support member supports the lighting film on at least two opposite sides of four sides of the lighting film having a rectangular shape so that the first surface and the second surface are arranged in a vertical direction.

15. The lighting device according to claim 12,
wherein the support member includes a groove configured to house an end portion of the lighting film.

16. The lighting device according to claim 15,
wherein a movement suppressing portion configured to suppress movement of the lighting film is provided between the support member and the lighting film.

17. The lighting device according to claim 16,
wherein the movement suppressing portion is a protrusion portion in contact with the lighting film provided on the support member.

18. The lighting device according to claim 17,
wherein the movement suppressing portion is constituted by a material having a Young's modulus lower than that of the support member.

19. The lighting device according to claim 17,
wherein the movement suppressing portion is constituted by a same material as the support member.

20. The lighting device according to claim 16,
wherein the movement suppressing portion is a bent portion provided in the lighting film by bending a portion of an end portion of the lighting film.

21. The lighting device according to claim 17,
wherein a ridge portion formed linearly along an end portion of the lighting film is provided on the protrusion portion.

22. The lighting device according to claim 17,
wherein one or more protruding portions are provided on the protrusion portion.

23. The lighting device according to claim 16,
wherein the movement suppressing portion has a concave-convex shape formed on a surface thereof.
